(19) United States
(12) Patent Application Publication
(10) Pub. No.: US 2014/0185808 A1
(43) Pub. Date: Jul. 3, 2014

(54) APPARATUS, SYSTEMS, AND METHODS FOR ENCRYPTION KEY DISTRIBUTION

(71) Applicant: Cloud Star Corporation, Mission Viejo, CA (US)

(72) Inventor: Safa Movassaghi, Mission Viejo, CA (US)

(73) Assignee: Cloud Star Corporation, Mission Viejo, CA (US)

(21) Appl. No.: 14/144,120

(22) Filed: Dec. 30, 2013

Related U.S. Application Data
(60) Provisional application No. 61/747,911, filed on Dec. 31, 2012.

(51) Int. Cl. H04L 9/08

(52) U.S. Cl. CPC H04L 9/0869
USPC 380/278

(57) ABSTRACT

Systems and methods are provided for distributing an encryption key. In some examples, a first computing system may be paired with a second computing system. A pseudo-random sequence of bytes may be generated for use as an encryption key in response to requests from the first and second computing systems, while distinct random sequences of bytes may be generated in response to requests from computing systems other than the first and second computing systems. The systems and methods provide secure communications between paired computing systems without key maintenance by the end users.

### CROSS REFERENCE TO RELATED APPLICATION

This application claims priority to U.S. Provisional Patent Application Ser. No. 61/747,911, filed Dec. 31, 2012 and entitled APPARATUS, SYSTEMS, AND METHODS FOR ENCRYPTION KEY DISTRIBUTION, the entire disclosure of which is herein incorporated by reference.

### BACKGROUND AND SUMMARY

With the development of the computer as both a business tool and a personal communication device, the number of secure transactions and communications that are performed between disparate computing devices has grown substantially. In order to maintain security in such transactions and communications, many different forms of cryptography are utilized to encrypt transmitted data. One such method, the one-time pad, offers a guarantee of security due to the randomness of the key but suffers from the drawback that the method may only maintain security when the pads are transmitted securely to the intended recipient of the messages that are to be encrypted using the one-time pad as a cipher.

Public-key cryptography resolves this by allowing users to set up a public and private key pair; the public key can be used to encrypt documents intended for the eyes of the holder of the private key. This mechanism works well for most scenarios and provides an acceptable level of security for most tasks, but includes generation and security of keys and certificates which is often outside the comfort zone of users.

The inventor herein has recognized these difficulties with the current encryption methods and, as described in more detail below, the inventor herein proposes an apparatus, systems, and methods for providing a one-time pad for one-to-one communication sessions which is discarded after use. In one example, a server system may perform a method for distributing an encryption key. The method may include pairing a first computing system with a second computing system, receiving a first request for a random number sequence, determining that the first request originated from the first computing system, and, in response, generating a pseudo-random sequence of bytes. The method may further include receiving a second request for a random number sequence, determining that the second request originated from the second computing system, and, in response, generating the pseudo-random sequence of bytes. The disclosed apparatus, systems, and methods further provide an encryption key that may be generated to any level of randomness and key length without any key maintenance by the end users.

### BRIEF DESCRIPTION OF THE FIGURES

The disclosure is illustrated by way of example and not by way of limitation in the figures of the accompanying drawings, in which the like references indicate similar elements and in which:

FIG. 1 shows an exemplary schematic illustration of an encryption key distribution system according to an embodiment of the present disclosure.

FIGS. 2A-2D shows an exemplary illustration of an encryption key distribution method according to an embodiment of the present disclosure.

FIG. 3 provides an example flow chart of an encryption key generation and distribution method according to an embodiment of the present disclosure.

FIG. 4 provides an example flow chart of an encryption key generation and distribution method according to an embodiment of the present disclosure.

FIG. 5 provides an example flow chart of an encryption key distribution and usage method according to an embodiment of the present disclosure.

### DETAILED DESCRIPTION

The present description contemplates systems and methods for distributing an encryption key, pairing a first computing system with a second computing system, receiving a first request for an encryption key comprising a pseudo-random sequence of bytes, determining that the first request originated from the first computing system and, in response, generating the pseudo-random sequence of bytes, receiving a second request for the encryption key comprising the pseudo-random sequence of bytes, and determining that the second request originated from the second computing system and, in response, generating the pseudo-random sequence of bytes. It will be appreciated that the pseudo-random sequence of bytes may be generated from an encryption seed. Receiving an additional request for the encryption key from the first computing system or the second computing system may, in response, generate a second pseudo-random sequence of bytes.

As described below, receiving a third request for the encryption key and determining that the third request originated from a computing system other than the first computing system and the second computing system may, in response, generate a random sequence of bytes, wherein the random sequence of bytes is different from the pseudo-random sequence of bytes. Additionally, receiving one or more additional requests for the encryption key originating from computing systems other than the first computing system and the second computing system may, in response, generate random sequences of bytes unique to each request. Further, a plurality of different engines may generate the random sequence of bytes unique to each request.

The pairing of the first computing system and the second computing system may comprise receiving a request from the first computing system for a secure connection to the second computing system and storing an association between the first computing system and the second computing system in a data storage system of the server system. Where identification and association information regarding the first computing system and the second computing system is stored, the determining that the first request or the second request originated from the first computing system or the second computing system may be based on the identification and association information. As described below, the first request and/or the second request may be generated as a result of an automatic trigger. As described below, after pairing the first computing system with the second computing system, a message may be sent to the second computing system including information regarding the secure connection.

A non-limiting example includes two computing devices initiating a secure connection with the assistance of a web server. The two devices, remote from each other, may attempt to initiate an encrypted secure connection. For example, the connection may involve a remote desktop application, where secure communications are vital to prevent a hostile third party from hijacking the session. Additionally, the connection may involve a video conference call or file transfer including sensitive information. In order to provide the two computing devices, remote from each other, with an encrypted secure connection, a server system, such as a web server, may be enlisted to generate and provide an encryption key to be distributed to each of the two devices. In one example, the key may be distributed by the web server on request. For example, the server may maintain information identifying the two devices as a pair and may distribute the key if the request originates from a source consistent with such information. If a request originates from a third party, in some examples an arbitrary randomly generated encryption key may be returned that is not the same as the encryption key associated with the paired devices. The two devices may, at this point, use the provided encryption keys to encrypt communications, such as those noted above, along the secure connection.

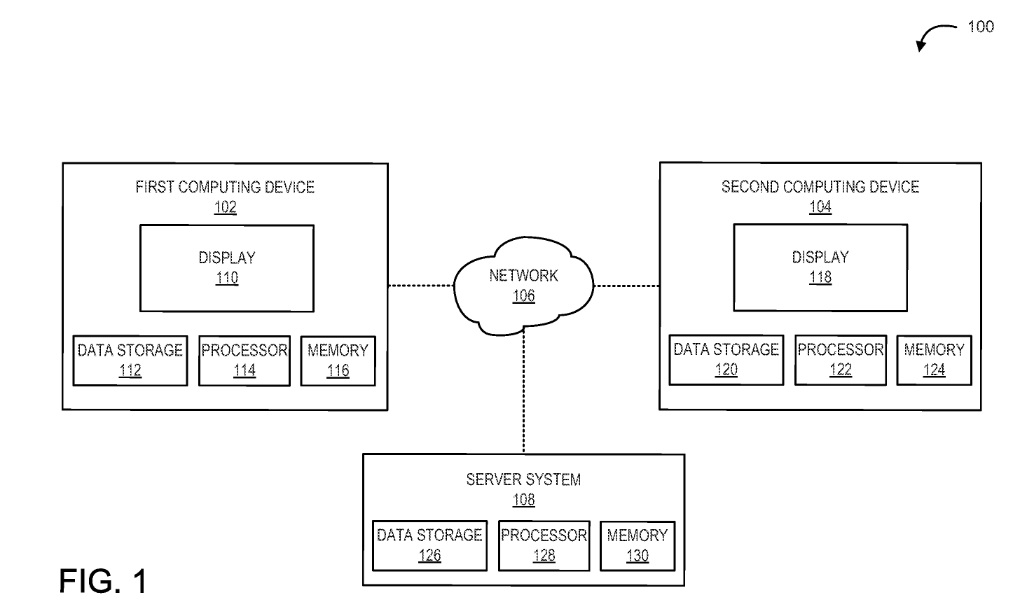

Turning now to the figures, FIG. 1 shows an exemplary schematic illustration of an encryption key distribution system 100 according to an embodiment of the present disclosure. As described below, the system enables a user to securely communicate with a remote computing system without generating or maintaining an encryption key.

As depicted in FIG. 1, an encryption key distribution system 100 may include a first computing system 102, a second computing system 104, a network 106, and a server system 108. The first and second computing system may be any suitable computing systems, such as a computing system that enables a user to store and maintain images and/or data. For example, the first and/or second computing system may be a smart phone, a hand-held computing device, a mobile device, a laptop computer, a portable media player, a desktop computer, etc. In some embodiments, the computing systems may run an identifiable operating system's software, such as a Windows operating system or other system, and may provide a standardized interface and platform for applications. The computing systems may be networked to one or more networks 106, such as a public network (e.g. the Internet), to enable communication between the computing systems and other elements included in the virtual desktop access and management system.

The first computing system 102 may include a display 110 configured to present images and/or graphics on the system. The first computing system may also include a communication apparatus facilitating wired and/or wireless communication between the computing system and external systems and systems such as through network 106. As depicted the first computing system may include various software applications stored on data storage system 112 (e.g., a hard drive, solid state memory, a rewritable disc, etc.,) and executable via a processor 114 using portions of memory 116.

Similarly, second computing system 104 may include a display 118, data storage system 120, a processor 122, and memory 124. The second computing system may be a host for a program, providing encrypted operational instruction to the first computing system. For example, the first computing system may be attempting to initiate a remote desktop interface with the second computing system. Alternatively, the second computing system may be a program target. For example, the first computing system may be attempting to initiate an encrypted video conference call with the second computing device.

It will be appreciated that first computing system 102 as a remote computing system may include any system that is not coupled directly to second computing system 104. Thus, the remote computing system may be a computing system in a hotel business center, a lobby, airport, client site, etc. The remote computing system may be in the same room, building or general area as the second computing system, or the two systems may be in different rooms, buildings, cities or countries. Alternatively, the remote computing system may be the second computing system in relation to the first computing system.

Furthermore, server system 108 may also include data storage system 126, a processor 128, and memory 130. The server system may be a public web server operating on a public network, such as the Internet, acting as a service for anyone with appropriate access—e.g., minimum system requirements, service membership, etc. Alternatively, the server system may be a private server, usable only to those affiliated with the host. For example, a corporate intranet service, such as a VPN or a remote desktop application.

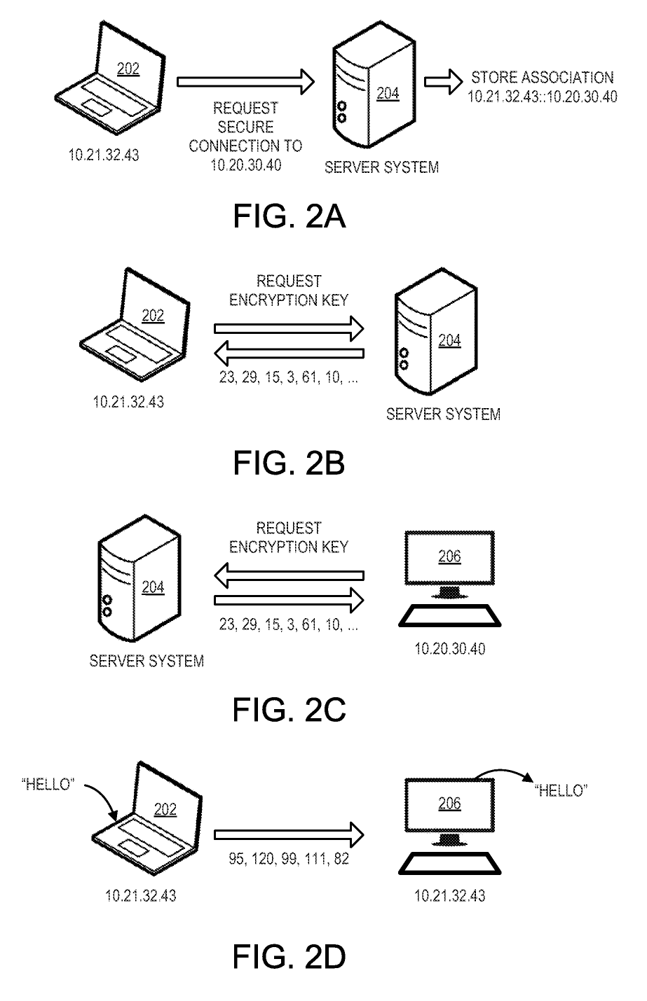

FIGS. 2A-2D depict an exemplary illustration of an encryption key distribution method according to an embodiment of the present disclosure. As described below, the first computing system coordinates with the server system in order to set up a secure connection to the second computing system. The server system distributes encryption keys to each of the paired computing systems and the computing systems begin communicating using the shared encryption.

Specifically, FIG. 2A illustrates a pairing process whereby first computing system 202 sends a request for a secure connection to an identified second computing system to server system 204. The second computing system may be identified by IP address, MAC address, PIN, fingerprint or an identifier from any other suitable identification method. In response to the request, the server system 204 stores identification and association information pertaining to the first computing system 202 as corresponding to identifying information pertaining to the second computing system.

The server system may optionally send a message, such as an alert or an authorization prompt, to the identified second computing system. The message may be used to alert the second computing system to the establishment of the secure connection. The message may also be used to determine whether the second computing system will allow the secure connection, or whether encrypted information from the first computing system will be received.

In FIG. 2B, the first computing system 202 sends a request to server system 204 for an encryption key. In the present example, the encryption key is a pseudo-random string of numbers, but the key may also be composed of characters, bytes, etc. In response, the server system 204 procedurally generates a pseudo-random string of numbers based on an encryption key seed associated with the paired systems. Using a specific encryption key seed allows the server system to ensure that when the first computing system and the second computing system request a “random” number sequence, the same pseudo-random number sequence may be generated twice identically and distributed to the requesting system.

In FIG. 2C, the second computing system 206 requests an encryption key. In response the server system 204 sends, to the second computing system 206, the same pseudo-random sequence of bytes that were sent to the first computing system 202. While the pseudo-random sequence of bytes is described above as being generated from an encryption key seed, it is also possible that server system 204 stores a randomly generated sequence of bytes in order to send to both paired systems.

It will be understood that while the figure depicts a request for the encryption key originating from second computing system 206, instead, an automatic trigger may instruct server system 204 to send the encryption key to second computing system 206. The automatic trigger may result from the first computing system's encryption key request, the request to server system 204 for a secure connection or any other suitable event. Additionally, the automatic trigger may send the request depicted in FIG. 2B, leading to server system 204 sending the encryption key to first computing system 202.

Finally, in FIG. 2D, the first computing system 202 communicates with the second computing system 206 by encrypting information with the shared encryption key—e.g., the pseudo-random sequence of bytes. For example, a text message, such as “HELLO”, is entered into the first computing system. The message is encrypted by the pseudo-random sequence of bytes and sent over the secure connection to the second computing device. Using an identical copy of the pseudo-random sequence of bytes, the second computing system decrypts the encrypted message to be displayed.

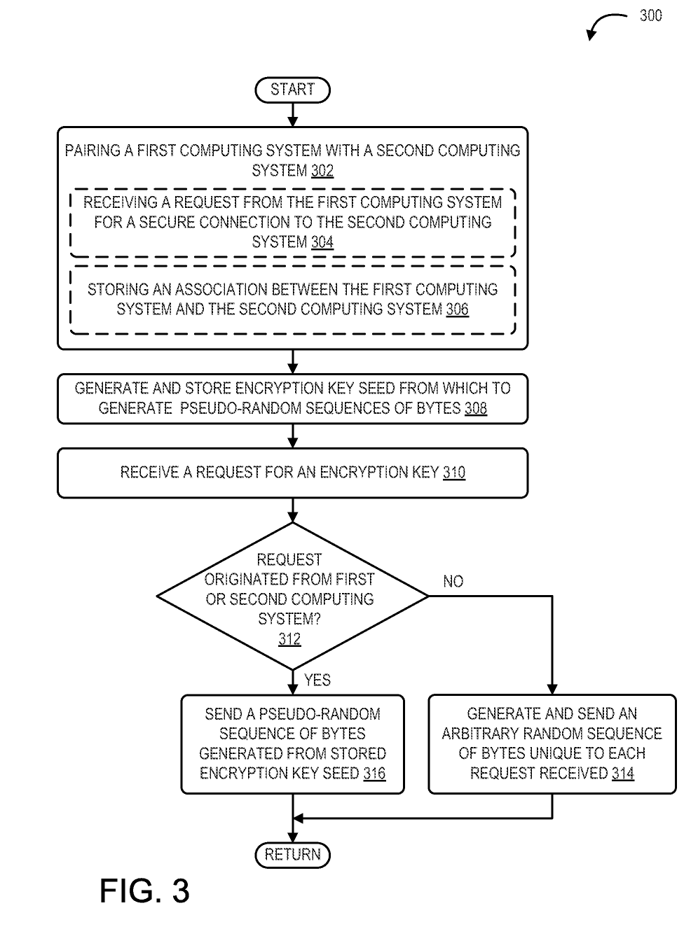

FIG. 3 provides an example flow chart of method 300, an encryption key distribution method according to an embodiment of the present disclosure. For example, the method 300 may be performed by a server system, such as server system 108 of FIG. 1. Method 300 includes, at 302, pairing a first computing system to a second computing system. As indicated at 304, the pairing may optionally include receiving a request from the first computing system for a secure connection to the second computing system. As further indicated at 306, the pairing may optionally include storing an association, including identification information, between the first computing system and the second computing system. Additionally, as shown at 308, the server system stores an encryption key seed from which pseudo-random sequences of bytes may be generated on request.

Method 300 includes, at 310, receiving a request for an encryption key in the form of an apparently random number sequence. The server system may then determine if the request originated from the first computing system or the second computing system, as indicated at 312. The determining may include matching information provided by the requesting computing system to information stored regarding the first computing system and the second computing system. One non-limiting example includes, in the case that the IP address is used for identification, the IP address of the requesting system is compared against the stored identification information, which may include the IP address of the first computing system and the second computing system. It will be understood that the identification may use MAC address, PIN, fingerprint or any other suitable identification method.

If the request originated from neither the first computing system nor the second computing system, method 300 includes generating a random sequence of bytes, numbers, characters, etc. that are unique to each request received, as indicated at 314. For example, if two different computing systems that are not paired each send a request for a random number sequence, the server system may generate two different random sequences of bytes, numbers, characters, etc. In contrast, if the request is determined to have originated from either the first computing system or the second computing system, the method 300 includes generating a pseudo-random sequence of bytes, numbers, characters, etc., as indicated at 316. Method 300 then returns to wait for further requests. As each byte, number character, etc. is used only once by each party, the paired computing systems may make multiple requests for encryption keys. Each new pair of requests may cause the server system to generate a new pseudo-random sequence from the encryption key seed to distribute to the paired computing systems such that each computing system possesses an identical encryption key.

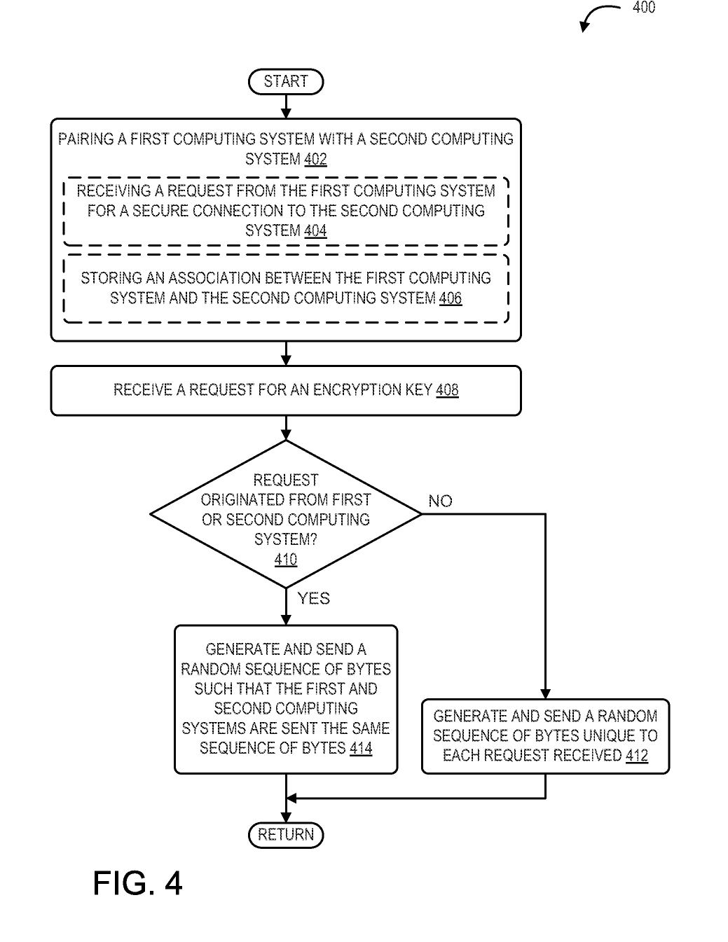

FIG. 4 provides a flow chart example of method 400, an encryption key distribution method according to a second embodiment of the present disclosure. For example, the method 400 may be performed by a server system, such as server system 108 of FIG. 1. Method 400 includes, at 402, pairing a first computing system to a second computing system. As indicated at 404, the pairing may optionally include receiving a request from the first computing system for a secure connection to the second computing system. As further indicated at 406, the pairing may optionally include storing an association, including identification information, between the first computing system and the second computing system.

Method 400 includes, at 408, receiving a request for an encryption key in the form of a random number sequence. The server system may then determine if the request originated from the first computing system or the second computing system, as indicated at 410. If the request originated from neither the first computing system nor the second computing system, method 400 includes generating and sending a random sequence of bytes, numbers, characters, etc. that are unique to each request received, as indicated at 412. For example, if two different computing systems that are not paired each send a request for a random number sequence, the server system may generate two different random sequences of bytes, numbers, characters, etc. In contrast, if the request is determined to have originated from either the first computing system or the second computing system, the method 400 includes generating a random sequence of bytes, numbers, characters, etc., as indicated at 414, such that the first computing system and the second computing system are sent the same sequence of bytes. Method 400 then returns to wait for further requests. As each byte, number character, etc. may be used only once by each party, the paired computing systems may make multiple requests for encryption keys. Each new pair of requests causes the server system to generate a new random sequence to distribute to the paired computing systems such that each computing system possesses an identical encryption key.

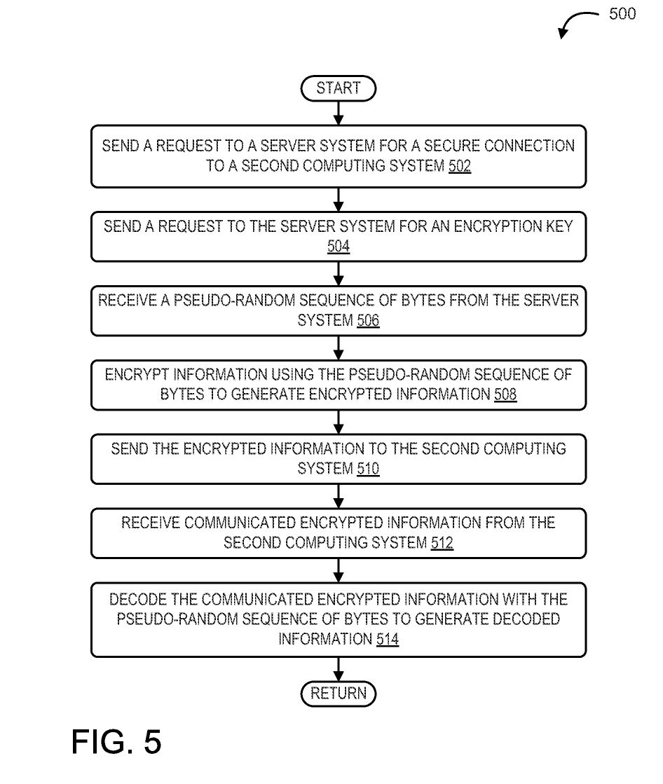

FIG. 5 provides an example flow chart of a method 500 of an encryption key distribution and usage method according to an embodiment of the present disclosure. For example, method 500 may be performed by a computing system, such as the first computing system 102 or the second computing system 104 of FIG. 1. Method 500 includes sending a request to a server system for a secure connection to a second computing system, as indicated at 502. Method 500 further includes sending a request to the server system for a random number sequence, as indicated at 504. In response, at 506, method 500 includes receiving a pseudo-random sequence of bytes, numbers, characters, etc. from the server system. Upon receiving the pseudo-random sequence of bytes, method 500 includes encrypting information using the pseudo-random sequence of bytes to generate encrypted information, as indicated at 508. The first computing system may send the encrypted information to the second computing system at 510 in order to begin securely communicating with the second computing system. Further, method 500 may include receiving communicated encrypted information from the second computing system at 512 and decoding the communicated encrypted information at 514. For example, the first computing system may use the pseudo-random sequence of bytes to generate decoded information in order to complete two-way secured communications with the second computing system.

The systems and methods described herein allow a user to easily and securely communicate with a remote computing system. The server system enables ease of administration and deployment of the associated encryption keys. The use of the server system enables encryption keys to be generated to any level of randomness and key length. Further, by providing a third-party server system for key distribution, the user may be able to utilize the secure encryption method without the responsibility of generating and managing the encryption keys.

In performing the secure communication session, the two parties to the communication session may set up a pairing on a server system. The server system may be configured to respond to requests for encryption keys by generating a random sequence of bytes unless the sequence is requested by one of the pairs, in which case a pseudo-random sequence of bytes is generated and the seed is stored securely on the server and associated with the paired computing systems. When the other party requests a random sequence, the same seed may be used and the server system may generate the same sequence. Both parties may repeat the process any number of times. Further, when the sequence of bytes runs out, a new key may be requested and the encryption key may be any length and may not be a fixed length.

The encryption key is used to encrypt communication between the two parties utilizing any existing encryption techniques. For example, the encryption may utilize simple XOR or even complex block ciphers such as AES, Blowfish, etc. The methods and systems utilize a middle-man server system to maintain the random number generator, register the pairs, provide a method for pair removal, provide the keys reliably and securely, and prevent unauthorized access. These are all achievable tasks for a competent server administrator and, for more secure facilities, more effort and expense may be put into access controls. Accordingly, the cost and effort may be shouldered by the provider—the user is provided with complete security simply by asking to be connected securely to another user. The ‘pairing’, key generation and encryption may be hidden from the user.

Random generation of encryption keys has been discussed above with respect to steps in a key distribution process and system. In order to achieve unpredictability with respect to malicious observers, multiple different engines may be used to generate the random sequence of bytes. The different engines may include random number generators, random sequence generators, list randomizers or any other suitable randomness engine. The more users requesting random numbers, the less likely that a pattern can be determined by a hostile observer.

The communication to the server system may use a conventional SSL tunnel to prevent all but the highest level hackers from snooping the wire. The path between systems may be further obfuscated by using TOR. Both parties may use any technique to verify their identity to the server system using anything from a simple PIN, to fingerprint or RSA ID. This may be used only to associate with the pairing inside the server system.

If a single user pairs two systems, the systems may each be given a different ID by the server system which corresponds to the pairing (e.g., a completely random number sequence for a first computing system, and another random number sequence for a second computing system). These IDs may then be encrypted using conventional public-key encryption technique (e.g., using the server system's public key to encrypt the ID) before sending through SSL to the server system. The server system then may use its private key to decrypt the ID and lookup the pair.

The two parties may connect at the same or different times. For example, a first user may encrypt an email to a second user that may be read at any time later as long as the server system keeps the pairing. In some embodiments, the first user may request the pairing be deleted from the server system if the first user changes his/her mind about the second user reading the message.

A web server may distribute encryption keys to a number of registered pairs of computing systems. In the case that a first computing system is paired with more than one second computing system, additional information may be provided in an encryption key request. The additional information may include identification information pertaining to the pair for which the encryption key is intended.

It will be appreciated that the first computing system may send a request to a server system for a secure connection to a second computing system. The first computing system may send a request for an encryption key comprising a pseudo-random sequence of bytes, receive the pseudo-random sequence of bytes from the server system, encrypt information using the pseudo-random sequence of bytes to generate encrypted information and send the encrypted information to the second computing system. As described below, the first computing system may receive communicated encrypted information from the second computing system, and may decode the communicated encrypted information using the pseudo-random sequence of bytes to generate decoded information. As described below, the second computing device may receive a message including information regarding the secure connection.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and sub-combinations of the various elements, features, functions and/or properties disclosed herein.

Inventions embodied in various combinations and sub-combinations of features, functions, elements, and/or properties may be claimed in a related application. Such claims, whether they are directed to a different invention or directed to the same invention, whether different, broader, narrower or equal in scope to any original claims, are also regarded as included within the subject matter of the inventions of the present disclosure.

1. A method, in a server system, of distributing an encryption key, the method comprising:
pairing a first computing system with a second computing system;
receiving a first request for an encryption key comprising a pseudo-random sequence of bytes;
determining that the first request originated from the first computing system and, in response, generating the pseudo-random sequence of bytes;
receiving a second request for the encryption key comprising the pseudo-random sequence of bytes;
determining that the second request originated from the second computing system and, in response, generating the pseudo-random sequence of bytes.

2. The method of claim 1, wherein the pseudo-random sequence of bytes is generated from an encryption key seed.

3. The method of claim 1, further comprising:
receiving an additional request for the encryption key from the first computing system or the second computing system and, in response, generating a second pseudo-random sequence of bytes.

4. The method of claim 1, further comprising:
receiving a third request for the encryption key, determining that the third request originated from a computing system other than the first computing system and the second computing system, and, in response, generating a random sequence of bytes, wherein the random sequence of bytes is different from the pseudo-random sequence of bytes.

5. The method of claim 4, further comprising:
receiving one or more additional requests for the encryption key originating from computing systems other than the first computing system and the second computing system and, in response, generating random sequences of bytes unique to each request.

6. The method of claim 5, wherein a plurality of different engines generate the random sequence of bytes unique to each request.

7. The method of claim 1, wherein pairing the first computing system with the second computing system comprises receiving a request from the first computing system for a secure connection to the second computing system, and storing an association between the first computing system and the second computing system in a data storage system of the server system.

8. The server system of claim 1, further comprising:
after pairing the first computing system with the second computing system, sending a message to the second computing system including information regarding the secure connection.

9. A server system including a memory storing instructions executable by a processor to:
pair a first computing system with a second computing system;
receive a first request for an encryption key comprising a pseudo-random sequence of bytes;
determine that the first request originated from the first computing system and, in response, generate the pseudo-random sequence of bytes;
receive a second request for the encryption key comprising a pseudo-random sequence of bytes;
determine that the second request originated from the second computing system and, in response, generate the pseudo-random sequence of bytes.

10. The method of claim 9, wherein the pseudo-random sequence of bytes is generated from an encryption key seed.

11. The method of claim 9, further comprising:
receive an additional request for the encryption key from the first computing system or the second computing system and, in response, generating a second pseudo-random sequence of bytes.

12. The method of claim 9, further comprising:
receiving a third request for the encryption key, determining that the third request originated from a computing system other than the first computing system and the second computing system, and, in response, generating a random sequence of bytes, wherein the random sequence of bytes is different from the pseudo-random sequence of bytes.

13. The method of claim 12, further comprising receiving one or more additional requests for the encryption key originating from computing systems other than the first computing system and the second computing system and, in response, generating random sequences of bytes unique to each request.

14. The method of claim 13, wherein a plurality of different engines generate the random sequence of bytes unique to each request.

15. The server system of claim 9, further comprising:
storing identification and association information regarding the first computing system and the second computing system, and wherein the determining that the first request or the second request originated from the first computing system or the second computing system is based on the identification and association information.

16. The server system of claim 9, wherein the first request and/or the second request are generated as a result of an automatic trigger.

17. The server system of claim 9, further comprising:
after pairing the first computing system with the second computing system, send a message to the second computing system including information regarding the secure connection.

18. A method, in a first computing system, for encrypting communication, the method comprising:
sending a request to a server system for a secure connection to a second computing system;
sending a request to the server system for an encryption key comprising a pseudo-random sequence of bytes;
receiving the pseudo-random sequence of bytes from the server system;
encrypting information using the pseudo-random sequence of bytes to generate encrypted information;
sending the encrypted information to the second computing system.

19. The method of claim 18, further comprising receiving communicated encrypted information from the second computing system, and decoding the communicated encrypted information using the pseudo-random sequence of bytes to generated decoded information.

20. The method of claim 18, further comprising:
receiving, at the second computing system, a message including information regarding the secure connection.
